(19) United States
(12) Patent Application Publication
(10) Pub. No.: US 2025/0263308 A1
(43) Pub. Date: Aug. 21, 2025

(54) WHOLE HOUSE WATER FILTER GASKET AND ALIGNMENT DEVICE

(71) Applicant: Robert Eugene Freudenberger, Woodstock, CT (US)

(72) Inventor: Robert Eugene Freudenberger, Woodstock, CT (US)

(21) Appl. No.: 19/058,481

(22) Filed: Feb. 20, 2025

Related U.S. Application Data
(60) Provisional application No. 63/556,182, filed on Feb. 21, 2024.

(51) Int. Cl. C02F 1/00

(52) U.S. Cl. CPC C02F 1/003; C02F 2201/004; C02F 2201/005; C02F 2201/006; C02F 2307/14

(57) ABSTRACT

A water filter gasket is configured as a flat structure having a gasket element and cartridge support elements extending from the gasket element towards a central axis. The gasket element provides a secure mating surface between the filter housing and inlet/outlet valve. The cartridge support elements provide an alignment aid during the attachment of the filter housing to the inlet/outlet valve. For example, the cartridge support elements aid in aligning the water filter cartridge along a central, longitudinal axis when placed into the filter housing. Such alignment mitigates the need to balance the filter cartridge within the filter housing while attaching the filter housing to the inlet/outlet valve.

### RELATED APPLICATIONS

This patent application claims the benefit of U.S. Provisional Application No. 63/556,182 filed on Feb. 21, 2024, entitled “Whole House Water Filter Gasket and Alignment Device,” the contents and teachings of which are hereby incorporated by reference in their entirety.

### BACKGROUND

Water sources for drinking water can include varying amounts of dissolved chemicals and suspended particulate materials. In order to improve water quality, end users, such as residences and businesses, typically use water filtration systems to mitigate these contaminants and particulates.

Over time, as a water filtration system operates, a water filter within the system can become loaded or clogged with particulates, thereby mitigating water flow through the system. As such, the water filter must be periodically changed. For example, a whole house water system typically includes a filter assembly having a filter housing, valve, and a filter disposed within the housing. During a replacement procedure for the filter, the end user typically disconnects the filter housing from the valve, removes the used water filter from the housing, replaces the used water filter with a new, unused filter, and reattaches the housing to the valve. By replacing the used water filter, the end user can ensure that clean water is supplied to the house.

### SUMMARY

Conventional water filtration assemblies suffer from a variety of deficiencies. For example, whole house water filter assemblies typically include an inlet/outlet valve disposed between a water source and a house's water outlet, a filter, and a filter housing which secures to the valve and contains the filter. These conventional water filter assemblies utilize an o-ring disposed within a groove between a filter housing and valve to mitigate water leakage from the assemblies during operation. During assembly, a user disposes the o-ring in a groove and places the filter into the housing. However, the relative geometries of the filter housing and filter requires the user to balance the filter at the center of the filter housing while aligning the filter with the valve as well as while engaging and rotating threads of the filter housing with the threads of the valve. With this arrangement, the filter may shift in the filter housing and prevent the aperture of the filter to properly align with an engagement member of the valve. As such, the user may be required to make multiple attempts to align the filter aperture with the valve engagement member to secure the filter housing to the valve.

Further, during these attempts, the o-ring can become dislodged from the groove. Following attachment of the filter housing to the valve, once water pressure is applied to the water filter assembly, the dislodged o-ring can cause the filter to leak. As such, the user must reassemble the filter housing to the valve while manipulating the o-ring and balancing the filter within the filter housing until any leaks are halted.

By contrast to conventional water filtration assemblies, embodiments of the present innovation relate to a whole house water filter gasket and alignment device. In one arrangement, the water filter gasket is configured as a flat structure having a gasket element and cartridge support elements extending from the gasket element toward a central axis. The gasket element provides a secure mating surface between a filter housing and inlet/outlet valve. The cartridge support elements aid in alignment of a water filter cartridge during the attachment of the filter housing to the inlet/outlet valve. For example, the cartridge support elements aid in aligning a central axis of an aperture of the water filter cartridge with a longitudinal axis of a filter engagement member of the inlet/outlet valve and securing the water filter cartridge along a central, longitudinal axis of the filter housing. Such alignment and securing mitigates the need to balance the water filter cartridge within the filter housing while attaching the filter housing to the inlet/outlet valve, as found in conventional filer assemblies.

The water filter gasket can be manufactured from a variety of materials. For example, the water filter gasket can be manufactured from an elastomeric material configured to provide alignment of the water filter cartridge along the central, longitudinal axis and to bend along the longitudinal axis in high water flow situations. This mitigates disturbance of water flow or pressure drop in the whole house water filter assembly during operation and maintains maximum water flow as needed. As such, because of the firmness/softness and shape of the water filter gasket, the water filter gasket replaces the o-ring in conventional whole house water filter assemblies while maintaining a fluid seal between the filter housing and inlet/outlet valve.

Embodiments of the innovation relate to a water filter gasket, comprising a gasket element and a set of cartridge support elements extending from the gasket element, the set of cartridge support elements configured to secure a water filter cartridge within a filter housing of a whole house water filter assembly.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a side sectional and partially exploded view of a whole house water filter assembly having a water filter gasket, according to one arrangement.

FIG. 2 illustrates a top view of the water filter gasket of FIG. 1, according to one arrangement.

FIG. 3 illustrates a top view of the water filter gasket installed within a filter housing relative to a water filter cartridge, according to one arrangement.

FIG. 4 is a perspective view of the water filter gasket installed within the filter housing relative to the water filter cartridge, according to one arrangement.

FIG. 5 illustrates a top view of a water filter gasket, according to one arrangement.

### DETAILED DESCRIPTION

By contrast to conventional water filtration assemblies, embodiments of the present innovation relate to a whole house water filter gasket and alignment device. In one arrangement, the water filter gasket is configured as a flat structure having a gasket element and cartridge support elements extending from the gasket element. The gasket element provides a secure mating surface between a filter housing and inlet/outlet valve. The cartridge support elements aid in alignment of a water filter cartridge during the attachment of the filter housing to the inlet/outlet valve. For example, the cartridge support elements aid in aligning a central axis of an aperture of the water filter cartridge with a longitudinal axis of a filter engagement member of the inlet/outlet valve and securing the water filter cartridge along a central, longitudinal axis of the filter housing. Such alignment and securing mitigates the need to balance the water filter cartridge within the filter housing while attaching the filter housing to the inlet/outlet valve, as found in conventional filer assemblies.

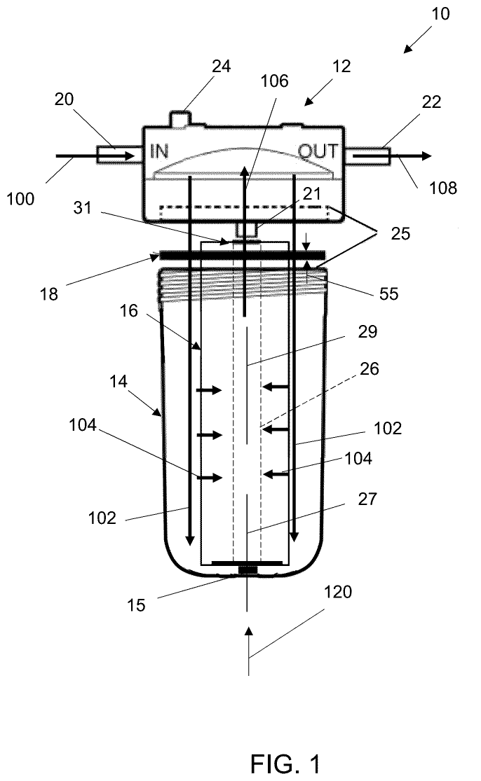

FIG. 1 illustrates a whole house water filter assembly 10, according to one arrangement. The whole house water filter assembly 10 includes a filter housing 14, an inlet/outlet valve or distributor 12, a water filter cartridge 16, and a water filter gasket 18.

The inlet/outlet valve 12 includes a water inlet 20, a water outlet 22, a vent 24 configured to remove pressure within the assembly 10 during maintenance, and a filter engagement member 25. The water inlet 20 is configured to be coupled to a water source while the water outlet 22 is configured to be coupled to a water dispenser in a house or business, such as a water faucet.

The water filter cartridge 16 is configured to be coupled with the filter engagement member 21 of the inlet/outlet valve 12. For example, a first end of a filter channel 26 defined by the water filter cartridge 16 can be disposed on the filter engagement member 21 and held longitudinally in place relative to the inlet/outlet valve 12 by the filter housing 14.

During operation, as water enters the water inlet 20 along flow direction 100, the water flows past the water filter gasket 18 into the filter housing 14 along flow direction 102. As the filter housing 14 becomes filled with water, the water travels along flow direction 104 into the water filter cartridge 16. As the water flows into the water filter cartridge 16, the water enters the filter channel 26 defined by the water filter 16, and travels within the filter channel 26 along flow direction 106 and enters the filter engagement member 21 of the inlet/outlet valve 12. From the filter engagement member 21, the water travels along flow direction 108 and exits the inlet/outlet valve 12 via the water outlet 22. With such flow, water entering the whole house water filter assembly 10 is filtered by the water filter cartridge 16 to remove particulate and contaminants from the water prior to being provided to the house or business.

The filter housing 14 is configured to contain the water filter cartridge 16 and to secure the water filter cartridge 16 to the inlet/outlet valve 12. In one arrangement, the inlet/outlet valve 12 and the filter housing 14 can include a sealing assembly 25 configured to couple the valve 12 and housing 14. For example, the sealing assembly 25 can define a first set of threads disposed about an outer periphery of an external surface of the filter housing 14 which mesh with second set of threads disposed about and defined by an inner periphery of an internal surface of the inlet/outlet valve 12. Further a base of the filter housing 14 can include a filter engagement member 15 configured to insert within a second end of the water filter channel 26 defined by the water filter cartridge 16. During assembly, as a user utilizes the sealing assembly 25 to couple the inlet/outlet valve 12 with the filter housing 14, the filter engagement member 15 generates a longitudinal load against the second end of the water filter channel 26 to secure the water filter cartridge 16 between the inlet/outlet valve 12 and the filter housing 14.

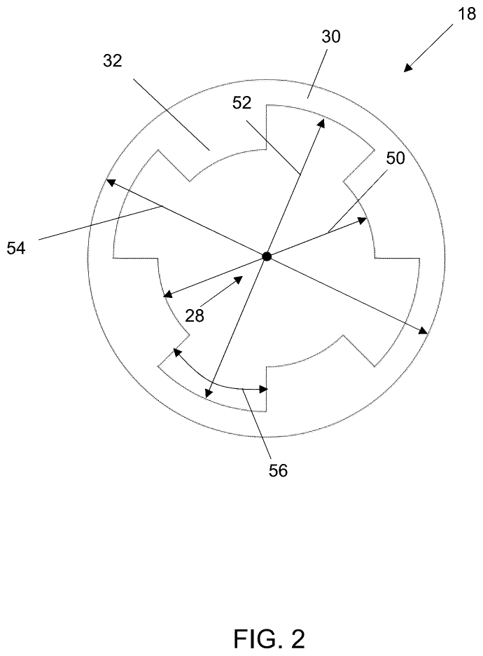

As indicated, in FIG. 1, the water filter gasket 18 is disposed between the inlet/outlet valve 12 and the filter housing 14. With additional reference to FIG. 2, the water filter gasket 18 is configured as a flat, disc-shaped structure having a gasket element 30 and cartridge support elements 32 extending from the gasket element 30.

The water filter gasket 18 can be configured with a variety of geometries. For example, the water filter gasket 18 can define a generally disc-shaped or circular structure having a thickness 55 of between about 0.125 inches and 0.25 inches. Further, with the presence of the gasket element 30 and cartridge support elements 32, the water filter gasket 18 can define a first inner diameter 50, such as between opposing cartridge support elements 32, of between about 2.4 inches and 2.6 inches, a second inner diameter 52, such as between opposing gasket element 30, of between about 3.5 inches and 3.4 inches, and an outer diameter 54 of between about 4.1 inches and 4.3 inches.

The water filter gasket 18 can be manufactured from a variety of materials. In one arrangement, the water filter gasket 18 can be manufactured from an elastomeric material, such as a silicon rubber material or ethylene propylene diene monomer (EPDM) rubber. Accordingly, the water filter gasket 18 can include a variety of durometer values. For example, the elastomeric material can have a durometer value of between about 50 and 80. In another example, the elastomeric material can have a durometer value of between about 70 and 80. In one arrangement, the water filter gasket 18 can be manufactured from a nylon material.

The gasket element 30 defines an outer periphery of the water filter gasket 18 and is configured to seal a contact surface between the filter housing 14 and inlet/outlet valve 12 to mitigate leakage of water during operation of the whole house water filter assembly 10. For example, during an assembly procedure, the filter housing 14 can compress the gasket element 30 against an outer periphery of the inlet/outlet valve 12. With such a configuration of the material properties and shape of the gasket element 30 of the water filter gasket 18, the gasket element 30 provides a relatively tight fluid seal between the filter housing 14 and the inlet/outlet valve 12 that is less prone to leakage than a conventional o-ring. As such, the water filter gasket 18 can replace the o-ring in conventional whole house water filter assembly 10.

The cartridge support elements 32 of the water filter gasket 18 extend from the gasket element 30 towards a water filter cartridge 16 and are configured to secure the water filter cartridge 16 in a central location within the filter housing 14 and align an aperture 31 of the water filter cartridge 16 with the filter engagement member 25 of the inlet/outlet valve 12 during assembly. As such, as a user engages the sealing assembly 25 of the filter housing 14 and the inlet/outlet valve 12 to move the housing along direction 120 as shown in FIG. 2, the first end of the filter channel 26 can correspondingly engage the filter engagement member 21. Such alignment allows for ease of reattachment of the filter cartridge 16 to the inlet/outlet valve 12 and the filter housing 14 to the inlet/outlet valve 12 following replacement of the water filter cartridge 16, without the need for the user to balance the filter cartridge 16 within the filter housing 14.

As shown, each of the cartridge support elements 32 extend from the outer periphery of the gasket element 30 toward a central or longitudinal axis 28 of the of the water filter gasket 18. While the water filter gasket 18 can include any number of cartridge support elements 32, in one arrangement, the water filter gasket 18 includes four cartridge support elements 32 distributed about the gasket element 30 at 90° increments, as shown in FIG. 2. Further, each of the cartridge support elements 32 define a radial spacing 56 with adjacent cartridge support elements 32. With such radial spacing 56, each of the cartridge support elements 32 can flex along and relative to the longitudinal axis 28 of the water filter gasket 18 either during installation or operation.

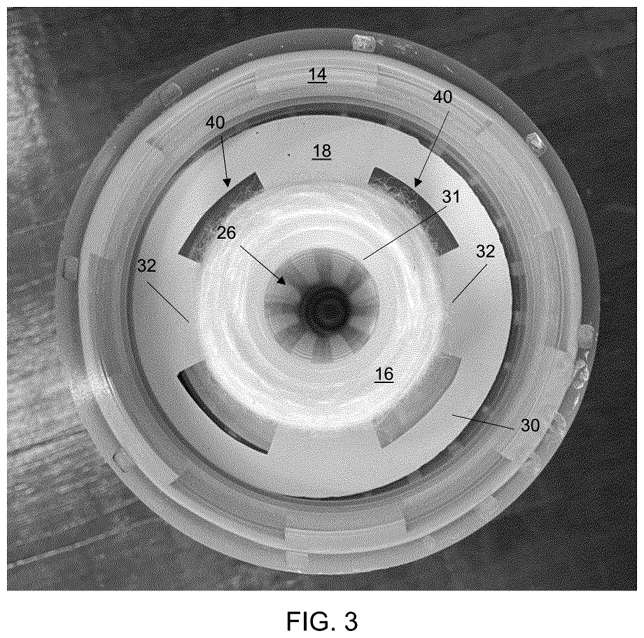

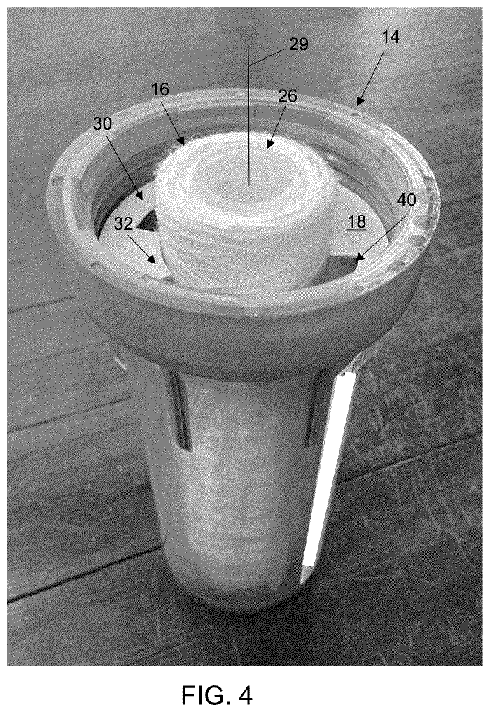

With additional reference to FIGS. 3 and 4, the cartridge support elements 32 are further configured to align a longitudinal axis 29 of the water filter cartridge 16 within the filter housing 14 along a central, longitudinal axis 27 of the housing 14. For example, during an installation procedure, as a user places the water filter cartridge 16 within the filter housing 14, the user can dispose the water filter gasket 18 about an outer periphery of the filter cartridge 16 such that the cartridge support elements 32 contact an outer periphery of the water filter cartridge 16. With such placement, the longitudinal axis 29 of the water filter cartridge 16 is substantially colinear with the longitudinal axis 28 of the water filter gasket 18. As the user inserts the water filter cartridge 16 and water filter gasket 18 within the filter housing 14, the cartridge support elements 32 secure the water filter cartridge 16 within the filter housing 14 to maintain the longitudinal axis 29 of the water filter cartridge 16 as substantially colinear with the longitudinal axis 27 of the filter housing 14. In turn, such positioning of the water filter cartridge 16 within the filter housing 14 aligns the aperture 31 of the water filter cartridge 16 with the filter engagement member 25 of the inlet/outlet valve 12. As the user secures the filter housing 14 to the inlet/outlet valve 12 via the sealing assembly 25, the cartridge support elements 32 of the water filter gasket 18 maintain the alignment of the water filter cartridge 16 relative to the filter engagement member 25 of the inlet/outlet valve 12.

The water filter gasket 18, thus, mitigates the need to physically balance the water filter cartridge 16 within the filter housing 14 while attaching the filter housing 14 to the inlet/outlet valve 12, as found in conventional water filtration assemblies. As such, the water filter gasket 18 provides a smooth, quick, and convenient method of replacing a water filter in a whole house water filter assembly 10.

Additionally, the water filter gasket 18 can mitigate disturbance of water flow or pressure drop in the whole house water filter assembly 10 during operation and maintain maximum water flow as needed. For example, the cartridge support elements 32 are configured to define a set of flow channels 40 relative to the water filter cartridge 16. The flow channels 40 allow water to flow from the inlet 20 of the inlet/outlet valve 12 past the water filter gasket 18 and into the filter housing 14. Additionally, in the case where the water filter gasket 18, including the cartridge support elements 32, is manufactured from an elastomeric material, during operation, the cartridge support elements 32 can bend (e.g., into the page of FIG. 2 along longitudinal axis 28) in relatively high-volume water flow situations to maintain water flow through the water filter assembly 10, as needed.

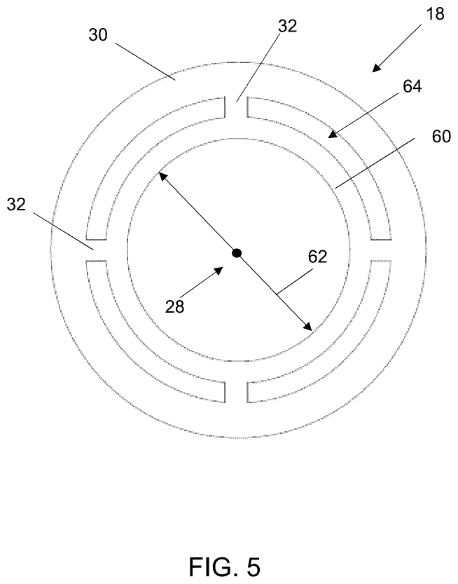

In one arrangement, the water filter gasket 18 can include a second gasket element 60 disposed about an inner periphery of the cartridge support elements 32. For example, with reference to FIG. 5, second gasket element 60 is configured as a circular structure that extends from each of the four cartridge support elements 32 toward the longitudinal axis 28 of the water filter gasket 18. While the second gasket element 60 can be configured with a variety of diameters, in one arrangement, the second gasket element 60 defines an inner diameter 62 of between about 2.5 inches and 2.6 inches. Further, the second gasket element 60 defines a set of flow channels 64 relative to the cartridge support elements 32 and gasket element 30. The flow channels 64 allow water to flow from the inlet 20 of the inlet/outlet valve 12 past the water filter gasket 18 and into the filter housing 14.

The second gasket element 60 is configured to maintain alignment of the water filter gasket 18 relative to the filter housing 14 during an installation procedure. For example, during installation, a user places the water filter gasket 18 of FIG. 5 over a water filter cartridge 16 and inserts the cartridge 16 into a filter housing 14. The second gasket element 60 aligns and maintains the longitudinal axis 29 of the water filter cartridge 16 as substantially colinear with the longitudinal axis 27 of the filter housing 14. As the user installs the filter housing 14 on the inlet/outlet valve 12, the second gasket element 60 further maintains the alignment of the gasket element 30 relative to the filter housing 14.

As provided above, the water filter gasket 18 is configured with cartridge support elements 32 that can contact the outer periphery of the water filter cartridge 16. Such a description is by way of example only. In one arrangement, one or more of the cartridge support elements 32 defines a gap or space relative to the outer periphery of the water filter cartridge 16. Such spacing can allow for ease of removal of the water filter gasket 18 from a used water filter cartridge 16 and installation of a new cartridge.

As provided above, the water filter gasket 18 is used as part of whole house water filter assembly 10. Such a description is by way of example only. In one arrangement, the water filter gasket 18 can be used in a product where a filter cartridge is placed inside a filter body and there are limited alignment provisions during reassembly. For example, the gasket 18 can be utilized in an oil filter assembly that uses a cartridge filter.

While various embodiments of the innovation have been particularly shown and described, it will be understood by those skilled in the art that various changes in form and details may be made therein without departing from the spirit and scope of the innovation as defined by the appended claims.

What is claimed is:

1. A water filter gasket, comprising:
a gasket element; and
a set of cartridge support elements extending from the gasket element,
the set of cartridge support elements configured to secure a water filter cartridge within a filter housing of a whole house water filter assembly.

2. The water filter gasket of claim 1, wherein the gasket element defines an outer periphery of the water filter gasket and is configured to seal a contact surface between the filter housing and an inlet/outlet valve.

3. The water filter gasket of claim 1, wherein each cartridge support element of the set of cartridge support elements extends from the gasket element toward a longitudinal axis of the of the water filter gasket.

4. The water filter gasket of claim 1, wherein each cartridge support element of the set of cartridge support elements defines a radial spacing with an adjacent cartridge support element.

5. The water filter gasket of claim 1, wherein the cartridge support elements are configured to align an aperture of a filter channel defined by the water filter cartridge with a filter engagement member of an inlet/outlet valve of the whole house water filter assembly.

6. The water filter gasket of claim 1, wherein the gasket element and the set of cartridge support elements are configured to define a set of flow channels relative to the water filter cartridge, the set of flow channels configured to allow water to flow from an inlet of an inlet/outlet valve of the whole house water filter assembly and into the filter housing.

7. The water filter gasket of claim 1, further comprising a second gasket element disposed about an inner periphery of the set of cartridge support elements.

8. The water filter gasket of claim 7, wherein the second gasket element defines a set of flow channels relative to the cartridge support elements and the gasket element, the set of flow channels configured to allow water to flow from an inlet of an inlet/outlet valve of the whole house water filter assembly and into the filter housing.

9. A whole house water filter assembly, comprising:
a filter housing;
a water filter cartridge disposed within the filter housing; and
a water filter gasket disposed on the water filter cartridge, the water filter gasket comprising:
a gasket element; and
a set of cartridge support elements extending from the gasket element,
the set of cartridge support elements configured to secure the water filter cartridge within the filter housing of the whole house water filter assembly.

10. The whole house water filter assembly of claim 9, wherein the gasket element defines an outer periphery of the water filter gasket and is configured to seal a contact surface between the filter housing and an inlet/outlet valve.

11. The whole house water filter assembly of claim 9, wherein each cartridge support element of the set of cartridge support elements extends from the gasket element toward a longitudinal axis of the of the water filter gasket.

12. The whole house water filter assembly of claim 9, wherein each cartridge support element of the set of cartridge support elements defines a radial spacing with an adjacent cartridge support element.

13. The whole house water filter assembly of claim 9, wherein the cartridge support elements are configured to align an aperture of a filter channel defined by the water filter cartridge with a filter engagement member of an inlet/outlet valve of the whole house water filter assembly.

14. The whole house water filter assembly of claim 9, wherein the gasket element and the set of cartridge support elements are configured to define a set of flow channels relative to the water filter cartridge, the set of flow channels configured to allow water to flow from an inlet of an inlet/outlet valve of the whole house water filter assembly and into the filter housing.

15. The whole house water filter assembly of claim 9, further comprising a second gasket element disposed about an inner periphery of the set of cartridge support elements.

16. The whole house water filter assembly of claim 15, wherein the second gasket element defines a set of flow channels relative to the cartridge support elements and the gasket element, the set of flow channels configured to allow water to flow from an inlet of an inlet/outlet valve of the whole house water filter assembly and into the filter housing.
